(19) United States
(12) Patent Application Publication
(10) Pub. No.: US 2022/0025205 A1
(43) Pub. Date: Jan. 27, 2022

(54) PROCESS FOR PREPARING POROUS FLUOROPOLYMER FILMS

(71) Applicant: Arkema France, Columbes (FR)

(72) Inventors: Manuel HIDALGO, PIERRE-BENITE CEDEX (FR); Aristide LAJOUX, PIERRE-BENITE CEDEX (FR)

(73) Assignee: Arkema France, Colombes (FR)

(21) Appl. No.: 17/298,123

(22) PCT Filed: Nov. 28, 2019
(86) PCT No.: PCT/EP2019/082966

§ 371 Date: May 28, 2021

(30) Foreign Application Priority Data
Nov. 30, 2018 (FR) 1872142

(51) Int. Cl. C09D 127/16; C09D 11/106; C09D 11/033; C09D 11/30; C09D 7/20; H01M 50/426; H01M 50/403; B01D 67/00; B01D 71/34; B01D 71/36; B01D 69/02

(52) U.S. Cl. CPC C09D 127/16; C09D 11/106; C09D 11/033; C09D 11/30; C09D 7/20; H01M 50/426; B01D 2325/02; B01D 67/0009; B01D 71/34; B01D 71/36; B01D 69/02; B01D 2323/22; H01M 50/403

(57) ABSTRACT

A process for preparing a porous film of a fluoropolymer, including the following steps: the provision of an ink including the fluoropolymer and a vehicle including a solvent for the fluoropolymer and a nonsolvent for the fluoropolymer, the solvent for the fluoropolymer and the nonsolvent for the fluoropolymer being mutually miscible; the deposition of the ink on a substrate; the evaporation of the vehicle comprising the solvent and the nonsolvent.

### FIELD OF THE INVENTION

The present invention relates to a process for preparing a porous fluoropolymer film.

### TECHNICAL BACKGROUND

Fluoropolymers such as polyvinylidene fluoride (PVDF) and copolymers derived therefrom have a large number of uses, in particular those in which they are applied in the form of a film to a substrate.

It is known practice, accordingly, to produce electroactive copolymers based on vinylidene fluoride (VDF) and trifluoroethylene (TrFE), which may optionally contain a third monomer such as chlorotrifluoroethylene (CTFE) or 1,1-chlorofluoroethylene (CFE). Other copolymers, based on VDF and hexafluoropropene (HFP), are useful for protecting, planarizing or passivating electronic devices or substrates.

Fluoropolymers of these kinds in film form may be applied from a formulation which is referred to as an “ink” and which is formed by mixing fluoropolymer and optionally additives in a vehicle composition.

However, in certain applications, notably in the field of electronics, batteries or filtration or separating membranes, it is necessary for the fluoropolymer films to be porous.

Thus, various processes have been developed to manufacture porous fluoropolymer films.

For example, the article by Tamaño-Machiavello et al., Hydrophobic/Hydrophilic P(VDF-TrFE)/PHEA Polymer Blend Membranes, Journal of Polymer Science, Part B: Polymer Physics, volume 54, pages 672-679, describes a process for obtaining mixed hydrophobic/hydrophilic membranes. In a first step, a porous membrane of a P(VDF-TrFE) copolymer is prepared. To do this, the copolymer is mixed with polyethylene oxide (PEO) as sacrificial pore-forming agent and the mixture is dissolved in N,N-dimethylformamide (DMF), which is a solvent for the fluoro copolymer. The solution is deposited on a support at a temperature of 70° C. and is then cooled to room temperature. The PEO is then removed from the membrane by immersing said membrane in water, which creates cavities or pores in place of the sacrificial PEO which dissolves in the water. The membrane must then be rinsed with water to thoroughly remove all the PEO. This process is a long multi-step process which uses a toxic solvent, DMF. Furthermore, the use of water may leave traces of moisture or ionic impurities in the porous film, which is not desirable.

Said article also mentions in general processes for manufacturing porous membranes involving steps of immersion/rinsing, temperature-induced phase separation (TIPS) and vapor-induced phase separation (VIPS). All these processes are multi-step or complex and difficult to implement or are based on the undesirable use of water.

There is thus a real need to provide a process for preparing a porous fluoropolymer film which is easier to implement, which does not require immersion of the film in water or the use of pore-forming polymers, which may contaminate the final membrane, or any temperature changes.

### SUMMARY OF THE INVENTION

The invention relates firstly to a process for preparing a porous film of a fluoropolymer, comprising the following steps:
the provision of an ink comprising the fluoropolymer and a vehicle comprising a solvent for the fluoropolymer and a nonsolvent for the fluoropolymer, said solvent for the fluoropolymer and said nonsolvent for the fluoropolymer being mutually miscible;
the deposition of the ink on a substrate;
the evaporation of the vehicle comprising the solvent and the nonsolvent.
   In this process:
   the nonsolvent is chosen from the group consisting of benzyl alcohol, benzaldehyde or a mixture thereof; and
   the solvent has a saturating vapor pressure at 20° C. higher than that of the nonsolvent, preferably at least 20 Pa higher.

In certain embodiments, the fluoropolymer is a polymer comprising units obtained from vinylidene fluoride and also units obtained from at least one other monomer of formula CX₁X₂═CX₃X₄, in which each group from among X₁, X₂, X₃ and X₄ is independently chosen from H, Cl, F, Br, I and alkyl groups comprising from 1 to 3 carbon atoms, which are optionally partially or totally halogenated; and preferably the fluoropolymer comprises units obtained from vinylidene fluoride and from at least one monomer chosen from trifluoroethylene, tetrafluoroethylene, chlorotrifluoroethylene, 1,1-chlorofluoroethylene, hexafluoropropene, 3,3,3-trifluoropropene, 1,3,3,3-tetrafluoropropene, 2,3,3,3-tetrafluoropropene, 1-chloro-3,3,3-trifluoropropene and 2-chloro-3,3,3-trifluoropropene; and more preferably the fluoropolymer is chosen from poly(vinylidene fluoride-co-hexafluoropropene), poly(vinylidene fluoride-co-trifluoroethylene), poly(vinylidene fluoride-ter-trifluoroethylene-ter-chlorotrifluoroethylene) and poly(vinylidene fluoride-ter-trifluoroethylene-ter-1,1-chlorofluoroethylene).

In certain embodiments, the solvent is chosen from the group consisting of ketones, esters, notably cyclic esters, dimethyl sulfoxide, phosphoric esters such as triethyl phosphate, carbonates, ethers such as tetrahydrofuran, and a mixture thereof, the solvent preferably being chosen from the group consisting of ethyl acetate, methyl ethyl ketone, γ-butyrolactone, triethyl phosphate, cyclopentanone, propylene glycol monomethyl ether acetate and a mixture thereof.

In certain embodiments, the solvent is γ-butyrolactone and the nonsolvent is benzyl alcohol, or the solvent is ethyl acetate and the nonsolvent is benzyl alcohol, or the solvent is methyl ethyl ketone and the nonsolvent is benzyl alcohol.

In certain embodiments, the vehicle comprises a mass proportion of nonsolvent for the fluoropolymer, as a percentage, in the range from (the solubility limit-60%) to the solubility limit, more preferentially in the range from (the solubility limit-60%) to (the solubility limit-10%), even more preferentially in the range from (the solubility limit-50%) to (the solubility limit-20%); and/or the vehicle comprises a mass proportion of solvent for the fluoropolymer, as a percentage, in the range from (100-the solubility limit) to (100-(the solubility limit-60%)), more preferentially in the range from (100-(the solubility limit-10%)) to (100-(the solubility limit-60%)), even more preferentially in the range from (100-(the solubility limit-20%)) to (100-(the solubility limit-50%)); relative to the total weight of the mixture of solvent and nonsolvent for the fluoropolymer, the solubility limit being expressed as a mass percentage.

In certain embodiments, the evaporation of the vehicle comprising the solvent and the nonsolvent is performed at a temperature of less than or equal to 60° C., preferably less than or equal to 50° C.

In certain embodiments, the deposition is performed by spin coating, spray coating, coating notably with a bar or a film spreader, slot-die coating, dip coating, roll-to-roll printing, screen printing, flexographic printing, lithographic printing or inkjet printing.

In certain embodiments, the ink does not comprise any sacrificial polymer.

In certain embodiments, the temperature applied during the evaporation of the vehicle comprising the solvent and the nonsolvent is essentially constant or varies by less than 20° C., preferably less than 10° C.

In certain embodiments, the process is a process for manufacturing a filtration or separating membrane, or a battery membrane.

The present invention also relates to a porous film that may be obtained via the above process, said film having a pore volume estimated by the Barrett-Joyner-Halenda method ranging from 0.020 cm³/g to 0.05 cm³/g, preferentially ranging from 0.025 cm³/g to 0.05 cm³/g.
The present invention also relates to a porous film that may be obtained via the above process, said film having a BET specific surface area of greater than or equal to 2 m²/g, preferably greater than or equal to 3 m²/g.

The present invention meets the need expressed above. It more particularly provides a simple process for preparing a porous fluoropolymer film, which is easy to implement and which does not necessarily require, during the formation of the film, the application of temperature changes or of temperatures other than the ambient temperature or other than a set temperature close to the ambient temperature. Furthermore, the process according to the invention does not require the use of other sacrificial polymers, notably hydrophilic polymers, which are difficult to remove and which may affect the purity of the films, nor the immersion of the film in nonsolvents and more particularly water which may leave traces of moisture or ionic impurities in the final porous films.

This is accomplished by means of using an ink whose liquid vehicle comprises a solvent for the fluoropolymer and a nonsolvent for the fluoropolymer, said solvent and said nonsolvent for the fluoropolymer being mutually miscible, the conditions for depositing the film being adjusted so as to make it possible to obtain porosity in the film using this ink.

Without wishing to be bound by a theory, the inventors think that the presence of nonsolvent might cause local precipitation of the fluoropolymer at the time of “drying” (i.e. during the evaporation of the vehicle from the ink deposited on a substrate), ultimately leading to the formation of pores.

According to certain particular embodiments, the invention may be performed using inks for which the vehicle has a favorable ecotoxicological profile.

### BRIEF DESCRIPTION OF THE FIGURES

FIG. 1 is a scanning electron microscope image of the film obtained via the process described in example 1.

FIG. 2 is a scanning electron microscope image of the film obtained via the process described in example 1.

FIG. 3 is a scanning electron microscope image of the film obtained via the process described in example 1.

FIG. 4A is a scanning electron microscope image of the film obtained via the process described in example 2, for evaporation performed at ambient temperature.

FIG. 4B is a scanning electron microscope image of the film obtained via the process described in example 2, for evaporation performed at 30° C.

FIG. 4C is a scanning electron microscope image of the film obtained via the process described in example 2, for evaporation performed at 40° C.

FIG. 4D is a scanning electron microscope image of the film obtained via the process described in example 2, for evaporation performed at 50° C.

FIG. 4E is a scanning electron microscope image of the film obtained via the process described in example 2, for evaporation performed at 60° C.

The horizontal white bar in the bottom right-hand corner of each image represents a length of 10 μm.

FIG. 5A is a light microscope image of the film obtained via the process described in example 2, for evaporation performed at ambient temperature.

FIG. 5B is a light microscope image of the film obtained via the process described in example 2, for evaporation performed at 30° C.

FIG. 5C is a light microscope image of the film obtained via the process described in example 2, for evaporation performed at 40° C.

FIG. 5D is a light microscope image of the film obtained via the process described in example 2, for evaporation performed at 50° C.

FIG. 5E is a light microscope image of the film obtained via the process described in example 2, for evaporation performed at 60° C.

The horizontal white bar in the bottom right-hand corner of each image represents a length of 100 μm.

FIG. 6 schematically represents a neural network which may be used for the implementation of the invention, in certain embodiments.

FIG. 7 schematically represents a computer system which may be used for the implementation of the invention, in certain embodiments.

### DETAILED DESCRIPTION

The invention is now described in greater detail and in a nonlimiting manner in the description that follows.

Unless otherwise indicated, all the percentages concerning amounts are mass percentages.

In the present patent application, the term “a fluoropolymer” should be understood as meaning “one or more fluoropolymers”. The same is also true for all the other species. Thus, for example, the term “a nonsolvent” should be understood as meaning “one or more nonsolvents”.

### Ink

The process according to the invention uses an ink comprising a fluoropolymer and a vehicle.

The fluoropolymer is preferably a polymer with a carbon chain which includes structural units (or units, or repeating units, or moieties) including at least one fluorine atom.

Preferably, the fluoropolymer comprises units obtained from (i.e. they are obtained by polymerization of) vinylidene fluoride (VDF) monomers.

In certain embodiments, the fluoropolymer is a PVDF homopolymer.

Preferably, however, the fluoropolymer is a copolymer (in the broad sense), meaning that it comprises units obtained from at least one monomer X other than VDF.

A single monomer X may be used, or a plurality of different monomers X, depending on the case.

In certain embodiments, the monomer X may be of formula CX₁X₂═CX₃X₄, in which each group X₁, X₂, X₃ and X₄ is independently chosen from H, Cl, F, Br, I and C1-C3 (preferably C1-C2) alkyl groups which are optionally partially or totally halogenated—this monomer X being different from VDF (i.e., if X₁ and X₂ represent H, at least one from among X₃ and X₄ does not represent F, and if X₁ and X₂ represent F, at least one from among X₃ and X₄ does not represent H).

In certain embodiments, each group X₁, X₂, X₃ and X₄ independently represents an H, F, Cl, I or Br atom or a methyl group optionally including one or more substituents chosen from F, Cl, I and Br.

In certain embodiments, each group X₁, X₂, X₃ and X₄ independently represents an H, F, Cl, I or Br atom.

In certain embodiments, only one from among X₁, X₂, X₃ and X₄ represents a Cl or I or Br atom, and the others of the groups X₁, X₂, X₃ and X₄ independently represent: an H or F atom or a C1-C3 alkyl group optionally including one or more fluorine substituents; preferably, an H or F atom or a C1-C2 alkyl group optionally including one or more fluorine substituents; and more preferably an H or F atom or a methyl group optionally including one or more fluorine substituents.

Examples of monomers X are as follows: vinyl fluoride (VF), trifluoroethylene (TrFE), tetrafluoroethylene (TFE), hexafluoropropene (HFP), trifluoropropenes and notably 3,3,3-trifluoropropene, tetrafluoropropenes and notably 2,3,3,3-tetrafluoropropene or 1,3,3,3-tetrafluoropropene (in the cis or, preferably, trans form), hexafluoroisobutylene, perfluorobutylethylene, pentafluoropropenes and notably 1,1,3,3,3-pentafluoropropene or 1,2,3,3,3-pentafluoropropene, perfluoroalkyl vinyl ethers and notably those of general formula R_{f}—O—CF═CF₂, R_{f} being an alkyl group, preferably a C1 to C4 alkyl group (preferred examples being perfluoropropyl vinyl ether or PPVE, and perfluoromethyl vinyl ether or PMVE).

In certain embodiments, the monomer X includes a chlorine or bromine atom. It may in particular be chosen from bromotrifluoroethylene, chlorofluoroethylene, chlorotrifluoroethylene and chlorotrifluoropropene. Chlorofluoroethylene may denote either 1-chloro-1-fluoroethylene or 1-chloro-2-fluoroethylene. The 1-chloro-1-fluoroethylene isomer (CFE) is preferred. Chlorotrifluoropropene is preferably 1-chloro-3,3,3-trifluoropropene (in cis or trans, preferably trans, form) or 2-chloro-3,3,3-trifluoropropene.

In certain preferred embodiments, the fluoropolymer comprises units obtained from VDF and HFP, or else is a P(VDF-HFP) polymer consisting of units obtained from VDF and HFP.

The molar proportion of repeating units obtained from HFP is preferably from 2% to 50%, notably from 5% to 40%.

In certain preferred embodiments, the fluoropolymer comprises units obtained from VDF and CFE, or from CTFE, or from TFE, or from TrFE. The molar proportion of repeating units obtained from monomers other than VDF is preferably less than 50%, more preferably less than 40%.

In certain preferred embodiments, the fluoropolymer comprises units obtained from VDF and TrFE, or else is a P(VDF-TrFE) polymer consisting of units obtained from VDF and TrFE.

In certain preferred embodiments, the fluoropolymer comprises units obtained from VDF, TrFE and another monomer X as defined above, different from VDF and from TrFE, or else is a P(VDF-TrFE-X) polymer consisting of units obtained from VDF, TrFE and another monomer X as defined above, which is different from VDF and from TrFE. In this case, preferably, the other monomer X is chosen from TFE, HFP, trifluoropropenes and notably 3,3,3-trifluoropropene, tetrafluoropropenes and notably 2,3,3,3-tetrafluoropropene or 1,3,3,3-tetrafluoropropene (in cis, or, preferably, trans form), bromotrifluoroethylene, chlorofluoroethylene, chlorotrifluoroethylene and chlorotrifluoropropene. CTFE or CFE are particularly preferred.

When units obtained from VDF and from TrFE are present, the proportion of units obtained from TrFE is preferably from 5 to 95 mol %, relative to the sum of the units obtained from VDF and TrFE, and notably: from 5 to 10 mol % or from 10 to 15 mol %; or from 15 to 20 mol %; or from 20 to 25 mol %; or from 25 to 30 mol %; or from 30 to 35 mol %; or from 35 to 40 mol %; or from 40 to 45 mol %; or from 45 to 50 mol %; or from 50 to 55 mol %; or from 55 to 60 mol %; or from 60 to 65 mol %; or from 65 to 70 mol %; or from 70 to 75 mol %; or from 75 to 80 mol %; or from 80 to 85 mol %; or from 85 to 90 mol %; or from 90 to 95 mol %. A range from 15 to 55 mol % is particularly preferred.

When units obtained from another monomer X, in addition to VDF and TrFE, are present (the monomer X notably being CTFE or CFE), the proportion of units obtained from this other monomer X in the fluoropolymer (relative to the total amount of the units) may range, for example, from 0.5 to 1 mol % or from 1 to 2 mol %; or from 2 to 3 mol %; or from 3 to 4 mol %; or from 4 to 5 mol %; or from 5 to 6 mol %; or from 6 to 7 mol %; or from 7 to 8 mol %; or from 8 to 9 mol %; or from 9 to 10 mol %; or from 10 to 12 mol %; or from 12 to 15 mol %; or from 15 to 20 mol %; or from 20 to 25 mol %; or from 25 to 30 mol %; or from 30 to 40 mol %; or from 40 to 50 mol %. Ranges from 1 to 20 mol %, and preferably from 2 to 15 mol %, are particularly suitable.

The molar composition of the units in the fluoropolymers may be determined by various means such as infrared spectroscopy or Raman spectroscopy. Conventional methods of elemental analysis of carbon, fluorine and chlorine or bromine or iodine elements, such as X-ray fluorescence spectroscopy, make it possible to calculate the mass composition of the polymers, from which the molar composition is deduced.

Use may also be made of multinuclear NMR techniques, notably proton (1H) and fluorine (19F) NMR techniques, by analysis of a solution of the polymer in a suitable deuterated solvent.

Finally, it is possible to combine elemental analysis, for example for the heteroatoms, such as chlorine or bromine or iodine, and NMR analysis. Accordingly, the content of units obtained from CTFE, in a P(VDF-TrFE-CTFE) terpolymer, for example, may be determined by measuring the content of chlorine by elemental analysis.

The viscosity of the fluoropolymer is preferably from 0.1 to 100 kPo (kilopoises) when measurement is performed at 230° C. and at a shear rate of 100 s⁻¹ (according to the standard ASTM D4440).

The fluoropolymer is preferably random and linear.

The fluoropolymer may be homogeneous or heterogeneous. A homogeneous polymer has a uniform chain structure, the statistical distribution of the units derived from the various monomers varying very little between the chains. In a heterogeneous polymer, the chains have a distribution of units derived from the various monomers of multimodal or spread-out type. A heterogeneous polymer thus comprises chains that are richer in a given unit and chains poorer in this unit.

The vehicle for the ink comprises a solvent for the fluoropolymer and a nonsolvent for the fluoropolymer. The solvent for the fluoropolymer and the nonsolvent for the fluoropolymer are mutually miscible.

The expression “vehicle comprising a/the solvent for the fluoropolymer and a/the nonsolvent for the fluoropolymer” means the combination notably of a solvent for the fluoropolymer with a nonsolvent for the fluoropolymer. This vehicle is preferably homogeneous at the molecular level.

The term “solvent for the fluoropolymer” means a liquid in which the fluoropolymer is capable of dissolving. The term “dissolution of the fluoropolymer in a solvent” means the formation of a true solution, i.e. a solution which is single-phased or homogeneous at the molecular level.

The term “nonsolvent for the fluoropolymer” means a liquid in which the fluoropolymer is incapable of fully dissolving (or in which the fluoropolymer is not completely soluble). The addition of the polymer to a nonsolvent does not make it possible to obtain a true solution, which is single-phased or homogeneous at the molecular level.

The solubility of the fluoropolymer in a given liquid may be determined, for example, by adding an amount of 5% w/w of fluoropolymer to said liquid at room temperature (for example 25° C.), with stirring, if necessary while heating moderately to a temperature of less than or equal to 60° C. (for example to a temperature of 60° C.), for example for 60 minutes, and then leaving to cool to room temperature (for example 25° C.) and visually observing, at this temperature, for example after 60 minutes, whether or not any solid polymer remains in suspension.

The term “miscible” means capable of mixing to form, in the absence of the polymer, a homogeneous mixture at the molecular level which is preferably transparent, without any trace of liquid/liquid phase separation.

The use of a vehicle in which the solvent and the nonsolvent are miscible allows easier handling of the ink and facilitates the preparation of the porous film.

The solvents and nonsolvents that may be used in the present invention may generally be any vehicle that is liquid at room temperature, and may notably be chosen from alcohols, ethers, halogenated vehicles, alkanes, cycloalkanes, aromatic vehicles, ketones, aldehydes, esters including cyclic esters, carbonates, phosphates, furans, amides and sulfoxides, and also combinations thereof.

As solvent for the fluoropolymer, any liquid vehicle which is capable of dissolving the fluoropolymer may be used. Preferably, the solvent is chosen from the group consisting of ketones, esters, notably cyclic esters, dimethyl sulfoxide, phosphoric esters such as triethyl phosphate, carbonates, ethers such as tetrahydrofuran, and a mixture thereof. Very volatile solvents are particularly preferred, in particular methyl ethyl ketone or ethyl acetate. The latter also has the advantage of having a favorable ecotoxicological profile. Sparingly volatile solvents may also be used, notably γ-butyrolactone, triethyl phosphate, cyclopentanone or propylene glycol monomethyl ether acetate. The solvent for the fluoropolymer may be a mixture of two or more of the above solvents.

Particularly preferably, the nonsolvent is benzyl alcohol, benzaldehyde or a mixture thereof. These nonsolvents offer the advantage both of being sparingly volatile and of having a favorable ecotoxicological profile (“green” nonsolvents).

Particularly advantageously, the nonsolvent is not water, and more preferably does not comprise any water.

Examples of combinations of solvent and of nonsolvent for the fluoropolymer that may be used in the invention are: ethyl acetate/benzyl alcohol; ethyl acetate/benzaldehyde; γ-butyrolactone/benzyl alcohol; γ-butyrolactone/benzaldehyde; triethyl phosphate/benzyl alcohol; triethyl phosphate/benzaldehyde; cyclopentanone/benzyl alcohol; cyclopentanone/benzaldehyde; propylene glycol monomethyl ether acetate/benzyl alcohol; propylene glycol monomethyl ether acetate/benzaldehyde; methyl ethyl ketone/benzyl alcohol; methyl ethyl ketone/benzaldehyde. Particularly preferably, the solvent is γ-butyrolactone and the nonsolvent is benzyl alcohol, or the solvent is ethyl acetate and the nonsolvent is benzyl alcohol, or the solvent is methyl ethyl ketone and the nonsolvent is benzyl alcohol.

Advantageously, the solvent may have a boiling point below that of the nonsolvent. This may make it possible to accelerate the precipitation of the fluoropolymer during the evaporation of the vehicle from the ink and to use inks comprising a lower proportion of nonsolvent for the fluoropolymer. Preferably, the solvent has a boiling point at least 10° C. below that of the nonsolvent, more preferably at least 20° C. below, more preferably at least 30° C. below.

Advantageously, the solvent may have a saturating vapor pressure at 20° C. higher than that of the nonsolvent. This may make it possible to accelerate the precipitation of the fluoropolymer during the evaporation of the vehicle from the ink and to use inks comprising a lower proportion of nonsolvent for the fluoropolymer. Preferably, the solvent has a saturating vapor pressure at 20° C. that is at least 20 Pa higher than that of the nonsolvent, more preferably at least 50 Pa higher, more preferably at least 100 Pa higher.

For a mixture comprising a given solvent and a given nonsolvent for the fluoropolymer, it is possible to determine a “solubility limit” (or dissolution limit) for the fluoropolymer in this mixture, at a certain temperature and at a certain polymer concentration; for the purposes of the invention, this “solubility limit” corresponds to the mass proportion of nonsolvent (relative to the total of the mixture of solvent and nonsolvent) at and above which the fluoropolymer precipitates in a macroscopically visible manner (i.e. visible to the naked eye) in the mixture. This solubility limit may be defined by determining the solubility of the fluoropolymer in mixtures with increasing mass proportions of nonsolvent, in the manner described above, but adding to the liquid the polymer at the concentration under consideration and visually observing whether or not any solid polymer remains in suspension at the temperature under consideration.

Preferably, the ink comprises a mass proportion of nonsolvent for the fluoropolymer, as a percentage, in the range from (the solubility limit-60%) to the solubility limit, more preferentially in the range from (the solubility limit-60%) to (the solubility limit-10%), even more preferentially in the range from (the solubility limit-60%) to (the solubility limit-20%), even more preferentially in the range from (the solubility limit-50%) to (the solubility limit
20%), relative to the total weight of the mixture of solvent and nonsolvent for the fluoropolymer, the solubility limit being expressed as a mass percentage and as defined in the preceding paragraph.

The use of nonsolvent in a mass proportion below the solubility limit, or even significantly below the solubility limit, may allow easier preparation of the ink and may make it possible to improve the stability of the ink over time.

In certain embodiments, the ink comprises a mass proportion of nonsolvent for the fluoropolymer, as a percentage, in the range from (the solubility limit-60%) to (the solubility limit-50%), or in the range from (the solubility limit-50%) to (the solubility limit-40%), or in the range from (the solubility limit-40%) to (the solubility limit-30%), or in the range from (the solubility limit-30%) to (the solubility limit-20%), or in the range from (the solubility limit-20%) to (the solubility limit-15%), or in the range from (the solubility limit-15%) to (the solubility limit-10%), or in the range from (the solubility limit-10%) to (the solubility limit-8%), or in the range from (the solubility limit-8%) to the solubility limit, relative to the total weight of the mixture of solvent and nonsolvent for the fluoropolymer, the solubility limit being expressed as a mass percentage.

Preferably, the ink comprises a mass proportion of solvent for the fluoropolymer, as a percentage, in the range from (100-the solubility limit) to (100-(the solubility limit-60%)), more preferentially in the range from (100-(the solubility limit-10%)) to (100-(the solubility limit-60%)), even more preferentially in the range from (100-(the solubility limit-20%) to (100-(the solubility limit-50%)), relative to the total weight of the mixture of solvent and nonsolvent for the fluoropolymer, the solubility limit being expressed as a mass percentage.

In certain embodiments, the ink comprises a mass proportion of solvent for the fluoropolymer, as a percentage, in the range from (100-(the solubility limit-50%)) to (100-(the solubility limit-60%)), or in the range from (100-(the solubility limit-40%)) to (100-(the solubility limit-50%)), or in the range from (100-(the solubility limit-30%)) to (100-(the solubility limit-40%)), or in the range from (100-(the solubility limit-20%)) to (100-(the solubility limit-30%)), or in the range from (100-(the solubility limit-15%)) to (100-(the solubility limit-20%)), or in the range from (100-(the solubility limit-10%)) to (100-(the solubility limit-15%)), or in the range from (100-(the solubility limit-8%)) to (100-(the solubility limit-10%)), or in the range from (100-the solubility limit) to (100-(the solubility limit-8%)), relative to the total weight of the mixture of solvent and nonsolvent for the fluoropolymer, the solubility limit being expressed as a mass percentage.

In other embodiments, the ink comprises from 0.1% to 5%, or from 5% to 10%, or from 10% to 20%, or from 20% to 30%, or from 30% to 40%, or from 40% to 50%, or from 50% to 60%, or from 60% to 70%, or from 70% to 80%, or from 80% to 90%, or from 90% to 95%, or from 95% to 99.9% by weight of solvent for the fluoropolymer relative to the total weight of liquid vehicle.

In certain embodiments, the ink comprises from 0.1% to 5%, or from 5% to 10%, or from 10% to 20%, or from 20% to 30%, or from 30% to 40%, or from 40% to 50%, or from 50% to 60%, or from 60% to 70%, or from 70% to 80%, or from 80% to 90%, or from 90% to 95%, or from 95% to 99.9%, by weight of nonsolvent for the fluoropolymer relative to the total weight of liquid vehicle.

The ink may contain from 0.1% to 60%, preferably from 0.5% to 30%, more preferably from 1% to 25%, more preferably from 3% to 20% by weight of polymer relative to the total weight of the ink. The polymer may consist of the above fluoropolymer, or may comprise said fluoropolymer and one or more additional polymers. The ink preferably comprises from 0.1% to 60%, more preferably from 0.5% to 30%, more preferentially from 1% to 25%, even more preferentially from 3% to 20% by weight of the fluoropolymer relative to the total weight of the ink.

Advantageously, the ink does not comprise any sacrificial polymer. The term “sacrificial polymer” (or “pore-forming polymer”) means a polymer which is intended to be removed to form the porous film, the removal of this polymer from the film creating pores in the film. Such a polymer is thus present in the ink serving for the formation of the film, but is not substantially present in the final porous film.

The ink may optionally comprise one or more additives, notably chosen from rheology modifiers, aging resistance modifiers, adhesion modifiers, pigments or dyes, and fillers (including nanofillers). The ink may also contain one or more additives which were used for the synthesis of the polymer(s).

However, particularly preferably, the ink does not comprise any rheology modifiers (also known as “rheological additives”), notably silica particles, calcium carbonate particles and/or crosslinked polymer particles. Preferably, the ink does not comprise any agents for modifying the surface or interface tension, such as surfactants.

In certain embodiments, when the aim is to crosslink the polymers after the composition has been applied, the ink comprises at least one crosslinking additive, preferably chosen from radical initiators, photoinitiators, co-agents such as molecules which are bifunctional or polyfunctional in terms of reactive double bonds, basic crosslinking agents such as diamines, and combinations thereof.

In other embodiments, there is no crosslinking additive, such as a photoinitiator or a crosslinking agent, present in the ink.

The total additives content is preferably less than 20% by weight, more preferably less than 10% by weight, relative to the total amount of polymers and additives.

The ink preferably has a nonvolatile solids content of 0.1% to 60%, preferably of 0.5% to 30%, more preferably of 1% to 25%, more preferably of 3% to 20% by weight.

### Deposition of the Ink

The ink described above is deposited onto a substrate. The substrate may be a surface of a metal, which may or may not be coated with a layer of oxide or nitride of said metal or of another metal, with a plastic, wood, paper, concrete, mortar or grout, glass, plaster, woven or nonwoven textile fabric, leather, etc. Preferably, the substrate is a glass or silicon surface, which may or may not be coated with silicon nitride or silicon oxides, or quartz, or polymer material (notably polyethylene terephthalate or polyethylene naphthalate), or with a metal other than silicon, or a mixed surface composed of several different materials, which may or may not be coated with passivating layers of metal oxides or nitrides.

The application of the ink may comprise spreading by discrete or continuous means. The deposition may notably be performed by spin coating, spray coating, coating notably with a bar or a film spreader (bar coating), slot-die coating, dip coating, roll-to-roll printing, screen printing, flexographic printing, lithographic printing or inkjet printing.

Preferably, the deposition of the ink on the substrate is performed at a temperature of less than or equal to 60° C., more preferentially less than or equal to 50° C., even more preferentially less than or equal to 40° C., for example at room temperature (between 15 and 30° C.).

### Film Formation

The vehicle comprising the solvent and the nonsolvent for the fluoropolymer is evaporated after the deposition. The layer of fluoropolymer (which may also optionally comprise one or more other polymers and/or additives) then solidifies to form a porous film.

In order to obtain a porous film, rather than a continuous film (i.e. a nonporous film), a temperature less than or equal to a “limit evaporation temperature” is applied during the step of evaporation of the vehicle from the ink (also known as the “drying” step in the present description). This limit evaporation temperature depends on the vehicle for the ink, notably on the solvent and the nonsolvent for the fluoropolymer, and on their proportions, and on the duration of the evaporation when this is less than a few hours.

Preferably, the temperature at which the evaporation of the vehicle from the ink is performed is less than or equal to 60° C., more preferentially less than or equal to 55° C., even more preferentially less than or equal to 50° C. For example, the evaporation of the vehicle from the ink is performed at a temperature ranging from 0 to 60° C., more preferentially from 5 to 55° C., even more preferentially at room temperature (from 15 to 30° C.). In certain embodiments, the temperature is from 0 to 5° C., or from 5 to 10° C., or from 10 to 15° C., or from 15 to 20° C., or from 20 to 25° C., or from 25 to 30° C., or from 30 to 35° C., or from 35 to 40° C., or from 40 to 45° C., or from 45 to 50° C., or from 50 to 55° C., or from 55 to 60° C., or from 60 to 65° C., or from 65 to 70° C.

The evaporation time may be, for example, from 1 minute to 48 hours, preferably from 5 minutes to 24 hours, more preferably from 10 minutes to 15 hours. During this time, the temperature can remain constant or can vary, provided that it remains less than or equal to the limit evaporation temperature. For example, the temperature may vary within the ranges mentioned above.

Advantageously, the temperature applied during the step of evaporation of the vehicle from the ink has a variation in the course of the step whose amplitude is less than or equal to 50° C., preferably less than or equal to 40° C., more preferentially less than or equal to 30° C., even more preferentially less than or equal to 20° C., even more preferentially less than or equal to 10° C. In certain embodiments, the temperature applied remains constant or essentially constant during the evaporation of the vehicle from the ink. The porosity of the film may be adjusted by varying the temperature during the evaporation step.

Preferably, the environment in which the evaporation of the vehicle is performed has a relative humidity of less than or equal to 10%, more preferably less than or equal to 5%, more preferably less than or equal to 3%, more preferably equal to 0%.

Advantageously, the process according to the invention does not comprise a step of immersing the fluoropolymer film in a liquid to create pores in said film, in particular there is no step of immersing the film in water or in an aqueous liquid.

The fluoropolymer layer thus constituted (after evaporation) may notably have a thickness of from 50 nm to 150 μm, preferably from 200 nm to 120 μm and more preferably from 500 nm to 100 μm.

In certain embodiments, a crosslinking step may be performed by subjecting the layer to radiation, such as to X-rays, gamma rays or UV rays, or by thermal activation.

The porous film preferably includes pores with a mean diameter of from 0.1 to 10 μm, more preferably from 0.2 to 5 μm, more preferably from 0.3 to 4 μm. The mean pore diameter may be measured by scanning electron microscopy.

The production of a porous film may be determined by observation of the film with a light microscope and/or an electron microscope (for example a scanning electron microscope) and/or by observation of the appearance of the film with the naked eye: a porous film has a white appearance, as opposed to the translucent or transparent appearance of a nonporous film.

### Applications

The porous fluoropolymer film may be used as an electroactive layer and/or as a dielectric layer in an electronic device, and notably when the fluoropolymer is a P(VDF-TrFE) or P(VDF-TrFE-CFE) or P(VDF-TrFE-CTFE) copolymer as described above and when the pores are filled with another liquid or solid substance, for instance an insulating oil, or an insulating electroactive or non-electroactive polymer, so that the composite layer obtained has dielectric properties.

When the porous film of the invention is used as a deposit on a substrate, one or more additional layers may be deposited onto the substrate equipped with the fluoropolymer film, examples being one or more layers of polymers, of semiconductor materials or of metals, in a manner known per se.

The term “electronic device” means either a single electronic component, or a set of electronic components, which are capable of performing one or more functions in an electrical or electronic circuit.

According to certain variations, the electronic device is more particularly an optoelectronic device, i.e. a device that is capable of emitting, detecting or controlling an electromagnetic radiation.

Examples of electronic devices, or where appropriate optoelectronic devices, to which the present invention relates are ferroelectric memories, transistors (notably field effect transistors), chips, batteries, electrodes, photovoltaic cells, light-emitting diodes (LEDs), organic light-emitting diodes (OLEDs), sensors, actuators, transformers, haptic devices, microelectromechanical systems (MEMS), and detectors.

The electronic and optoelectronic devices are used in and integrated into numerous electronic devices, items of equipment or sub-assemblies and in numerous objects and applications, such as televisions, computers, mobile telephones, rigid or flexible screens, thin-film photovoltaic modules, lighting sources, energy sensors and converters, medical appliances, floors and walls, roofs and ceilings, etc.

In any case, the electronic device may notably comprise a substrate bearing electronic elements, which may comprise layers of conductive material, of semiconductor material, and others. The electronic elements are preferably on a single face of the substrate, but in certain embodiments they may be on both faces of the substrate. The porous layer according to the invention may form an integral part of the electronic components, may cover all or a portion of the electronic elements, and all or a portion of the substrate.

The porous film may also be used in an electronic device, such as an ultrasonic detector or emitter, as layers absorbing ultrasound waves.

It may also be used as, or for the manufacture of, a separating membrane in a battery, for example in a lithium-based battery.

The porous fluoropolymer film may also be used as, or for the manufacture of, a filtration or microfiltration membrane, or a separating membrane, such as a separating membrane in a liquid/liquid, liquid/gas, liquid/solid, gas/gas or solid/solid separating device.

### Preparation of the Ink

The ink may be prepared by dispersing the fluoropolymer, in solid form, (and optionally the other polymers) into the vehicle comprising the solvent and the nonsolvent for the fluoropolymer, and, preferably, by performing mixing.

The temperature applied during the preparation is preferably from 0 to 100° C., more preferably from 10 to 75° C., more preferably from 15 to 60° C., and ideally from 20 to 30° C. In certain embodiments, the preparation is performed at room temperature. Advantageously, the preparation is performed with moderate stirring.

The vehicle comprising the solvent and the nonsolvent for the fluoropolymer may be prepared by mixing the solvent for the fluoropolymer with the nonsolvent for the fluoropolymer. This mixture may be prepared before, during or after incorporating the fluoropolymer (and/or the other optional polymers), i.e. the fluoropolymer may be dispersed in the already-mixed solvent and nonsolvent, or the fluoropolymer, the solvent and the nonsolvent may be added at the same time, or the fluoropolymer may be added to the solvent or to the nonsolvent, the nonsolvent or the solvent being added afterwards.

When additives must be added to form the ink according to the invention, they may be added before, during or after the dispersing of the polymers in the liquid vehicle.

The solvent and the nonsolvent for the fluoropolymer may be a known solvent or a known nonsolvent for the fluoropolymer. Alternatively, the solubility of the fluoropolymer in a given liquid vehicle may be evaluated, so as to determine whether this vehicle is a solvent or a nonsolvent for the fluoropolymer, for example in the manner described above.

According to other embodiments, the solubility of the fluoropolymer in a given liquid vehicle may be determined via a process performed by computer. This process is based on a function configured to associate a probability of solubility of the fluoropolymer with solubility parameters of a vehicle composition, for example determined by learning.

### Function Determined by Learning

Preferably, the above function is determined via a process performed by computer.

The determination of this function may be based on the formation of a set of learning data followed by the learning of the function on the basis of the set of learning data.

The set of learning data comprises, for several respective vehicle compositions:
a plurality of solubility parameters for the vehicle composition;
in association with information regarding the solubility of the fluoropolymer in the vehicle composition under consideration.

The term “association” means herein that there is a connection between the data under consideration for each vehicle composition. Thus, the solubility parameters and the information regarding the solubility may be featured in a relational database. For example, the solubility parameters and the information regarding the solubility may be given in respective fields of the same base.

The information regarding the solubility of the fluoropolymer is preferably binary information of yes/no type, i.e. soluble or insoluble. It may thus be coded, for example, in the form of a 0 or of a 1. This information may, if necessary, be determined by an experimental test for each vehicle composition of the set of learning data, for example by adding a certain amount of fluoropolymer to the vehicle composition, stirring, if necessary with moderate heating (for example to a temperature of less than or equal to 60° C., or less than or equal to 50° C., or less than or equal to 40° C.), but preferably at room temperature, and by visually observing after 15 or 60 minutes, for example, whether or not any solid polymer remains in suspension. The amount of fluoropolymer used in the test may notably be from 1% to 10% w/w, preferably about 5% w/w.

There may notably be two, or preferably three, solubility parameters for the vehicle composition.

It is in particular preferred to choose the solubility parameters from among the Hansen solubility parameters.

The Hansen solubility parameters are as follows:
δ_{d}: dispersive component (energy associated with the dispersion forces between the molecules of the composition);
δₚ: polar component (energy associated with the intermolecular dipolar forces between the molecules of the composition); and
δₕ: hydrogen component (energy associated with the hydrogen bonds between the molecules of the composition).

Preferably, all the Hansen solubility parameters are provided at the same reference temperature, for example 25° C.

The solubility parameters used in the set of learning data may thus be δ_{d} and δₚ; or δ_{d} and δₕ; or δₚ and δₕ; or particularly preferably δ_{d}, δₚ and δₕ.

The Hansen solubility parameters may be given in MPa^{1/2} or in any other unit (for example in (cal/cm³)^{1/2}).

The solubility parameters may be determined by experimental tests combined with theoretical considerations (semiempirical methods). Thus, for example, Hoy determined the components δ_{d}, δₚ and δₕ semiempirically using (Handbook of Solubility Parameters, and Other Cohesion Parameters, 1983 edition, page 59):
1. Experimental evaluation of the Hildebrand solubility parameter expressed as δₜ (Hildebrand solubility parameter)=(δ_{d}²+δₚ²+δₕ²)^{1/2} (measurements of enthalpy of evaporation and use of state equations).
2. Estimation of δₕ from an aggregation number obtained from an equation derived from the regression of the molar volume as a function of the ratio Tb/Tc (boiling point, crystallization point), the molecular mass and the density.
3. Calculation of the parameter δₚ by a method of contribution of groups to the molar attraction.
4. Deduction of the parameter δₚ, by difference, from the expression of the Hildebrand solubility parameter (point 1).

Preferably, the solubility parameters are obtained from one or more pre-existing reference tables. The term “reference table” means a compilation of data relating to the cohesive energy (which ultimately reflect the solubility parameters) of various vehicle compositions, these data being obtained from experimental or semiempirical studies performed according to the same methodology, and preferably with the same apparatus and by the same team.

In certain embodiments, all the solubility parameters for the set of learning data come from the same reference table. In other embodiments, the solubility parameters for the set of learning data come from two or more than two different reference tables. It has been found, surprisingly, that the use of data obtained from at least two different reference tables leads to the determination of a reliable function. The use of at least two different reference tables may be advantageous insofar as it can minimize the risk of bias or of error in the learning data. It is thus possible to integrate into the set of learning data a first set of solubility parameters for a given vehicle composition, obtained from a first reference table, and a second set of solubility parameters for the same given vehicle composition, obtained from a second reference table. It is also possible to proceed in this way for several given vehicle compositions or for all the vehicle compositions.

By way of example, the solubility parameters may be obtained from a reference table contained in the CRC Handbook of Solubility Parameters and Other Cohesion Parameters, by Allan F. M. Barton, 2^{nd} edition (1991), and, for example, from table 2 of chapter 7 and/or from table 5 of chapter 8 of this publication.

The vehicle compositions for the set of learning data may be pure substances and/or mixtures of substances. The term “pure substance” is used as opposed to “mixture of substances”. A pure substance thus preferably has a mass purity of greater than or equal to 98%, or 99%, or 99.5%, or 99.9%. It is understood that, for the purposes of the present patent application, a pure substance may contain small amounts of impurities.

When mixtures of substances are taken into consideration, the solubility parameters may be determined by experimental or semiempirical tests, or may preferably be calculated in the form of a linear combination from the solubility parameters of the pure substances as a mixture. In such a linear combination, the weighting coefficients applied preferably correspond to the volume proportions of each of the substances.

The set of learning data may be divided into a set of training data and a set of test data. Learning may then be performed by carrying out sequences of a training phase (on the set of training data) and of a test phase (on the set of test data), until the test phase gives a positive result (i.e. until the test phase meets a validation criterion). Alternatively, the set of learning data may consist entirely of the set of training data, and no test phase is performed, or alternatively the test phase is performed on additional data.

It is also possible to envisage that the set of learning data is successively divided N times differently into a set of training data and a set of test data. Each time, the training phase and test phase sequences are performed as described above. This results in obtaining N different models. The model having the best statistical validation (the smallest error) is chosen as the final model for the function.

This method is particularly suitable when the set of learning data is of modest size, since it affords efficient use of a limited amount of data.

The learning may be performed by “machine learning”, according to any technique known to those skilled in the art.

The learning may in particular be based on a neural network model.

The neural network may be a binary response network (network of perceptrons) or a gradual response network, giving a probability, for example in the form of any value between 0 and 1 (for example a sigmoid neural network).

The neural network includes an input layer, one or more intermediate layers, or hidden layers, and an output layer.

The input layer contains part of the learning data. It feeds a single intermediate layer or hidden layer, or else a succession of intermediate layers or hidden layers, which themselves feed the output layer.

Each intermediate layer performs a numerical operation using the data obtained from the preceding layer, the numerical operation involving variable parameters. The result of the numerical operation feeds the next layer.

The output layer also performs a numerical operation using the data obtained from the preceding layer, the numerical operation involving variable parameters. The result of the numerical operation gives an estimation of probability of solubility.

An error function is then calculated using this estimation of probability of solubility and the information regarding the corresponding solubility which is featured in the set of learning data. The variable parameters of the intermediate layer(s) and of the output layer are optimized so as to minimize the error function. The network can, in certain cases, back-feed itself with calculation results (outputs) becoming inputs for neurons of the layer under consideration or for preceding layers. Preferably, a network without feedback is used.

By way of example, and with reference to FIG. 6, the solubility parameters 1, 2, 3 may be supplied as input to three neurons 4, 5, 6 of a single intermediate layer, which themselves feed an output layer 7.

Each of the intermediate neurons 4, 5, 6 calculates a numerical function from the solubility parameters 1, 2, 3. The numerical function may comprise, for example, a linear or affine combination of the solubility parameters 1, 2, 3, the coefficients (weights) of the linear or affine combination corresponding to variable parameters as described above; the numerical function may also comprise the application of another mathematical function to such a linear or affine combination, for example the application of a hyperbolic tangent function.

The output layer 7 calculates a numerical function from the values obtained from the intermediate neurons 4, 5, 6.

In certain embodiments, a threshold may be associated with each intermediate neuron 4, 5, 6. Each intermediate neuron 4, 5, 6 is thus activated or not activated with respect to the output layer 7, i.e. it feeds or does not feed the output layer 7, depending on whether or not the calculated value of the numerical function meets a defined condition relative to the threshold. The threshold, just like the weights, represents a variable parameter as described above.

The numerical function of the output layer 7 may comprise, for example, a linear or affine combination of the values obtained from the intermediate neurons 4, 5, 6, the coefficients of the linear or affine combination corresponding to variable parameters as described above; the numerical function may also comprise the application of another mathematical function to such a linear or affine combination, for example the application of a hyperbolic tangent function or any other exponential function or combination of exponential functions.

When the neural network is a binary response network, the value resulting from the numerical function of the output layer 7 is compared with a predetermined threshold, to give a response of yes/no type, which may be coded, for example, in the form of a 0 or of a 1.

When the neural network is a gradual response network, the value resulting from the numerical function of the output layer 7 is, for example, any value between 0 and 1, indicating a probability of solubility of the fluoropolymer in the vehicle composition.

In one case as in the other, the value resulting from the numerical function of the output layer 7 is compared with the information regarding the solubility of the polymer (for example coded in the form of a 0 or of a 1) and an error function is calculated.

The above steps are repeated a certain number of times, both while varying the variable parameters (weight, threshold) of the intermediate neurons 4, 5, 6 and of the output layer 7, and while varying the data obtained from the set of learning data, so as to minimize the error function.

On conclusion of the process, a function configured to associate a probability of solubility of the fluoropolymer with a vehicle composition is obtained. This function is determined according to the values of the variable parameters (weight, threshold) optimized by the preceding process.

### Selection of Substances or of Mixtures of Substances

The function configured to associate a probability of solubility of a fluoropolymer with a vehicle composition may be used in a process performed by computer to select the solvent for the fluoropolymer and/or the nonsolvent for the fluoropolymer and/or the proportions of solvent and of nonsolvent for the fluoropolymer in the vehicle comprising the solvent for the fluoropolymer and the nonsolvent for the fluoropolymer.

Thus, in general, the function may be used to obtain a probability of solubility of the fluoropolymer for a vehicle composition to be tested, which is not featured in the set of learning data.

This function is then applied to the solubility parameters of the vehicle composition to be tested.

The probability of solubility obtained by applying the function represents an estimation of the ability of the fluoropolymer to be dissolved in the vehicle composition. This estimation may be obtained either in binary form (yes/no response) or in the form of any probability (for example any value from 0 to 1). In this second case, the probability is compared with a threshold value so as to define whether the fluoropolymer is estimated to be soluble or insoluble in the vehicle composition.

Depending on the test result, the vehicle composition to be tested may or may not be adopted.

In certain embodiments, the function is applied successively to a plurality of vehicle compositions to be tested, so as to select one or more of these compositions.

The vehicle compositions to be tested may be pure substances or mixtures of substances.

When they are pure substances, the solubility parameters to which the function is applied may be determined by experimental or semiempirical tests, as illustrated above, or, preferably, may be obtained from one or more pre-existing reference tables, as described above.

When they are mixtures, the solubility parameters to which the function is applied may be determined by experimental or semiempirical tests, or, preferably, may be calculated in the form of a linear combination from the solubility parameters of the pure substances as a mixture. In such a linear combination, the weighting coefficients applied preferably correspond to the volume proportions of each of the solvents.

The function and/or the selection process described above may be used for selecting a solvent for the fluoropolymer; a solvent is then adopted if the fluoropolymer is estimated to be soluble therein.

The function and/or the selection process described above may also be used for selecting a nonsolvent for the fluoropolymer; a nonsolvent is then adopted if the fluoropolymer is estimated to be insoluble therein.

The function and/or the selection process described above may also be applied for selecting the proportions of solvent for the fluoropolymer and of nonsolvent for the fluoropolymer in the vehicle used for the preparation of the ink.

In this case, the vehicle composition to be tested, with the solubility parameters for which the function is applied, is a mixture comprising the solvent for the fluoropolymer and the nonsolvent for the fluoropolymer.

In preferred embodiments, the function is applied successively to a plurality of vehicle compositions to be tested all consisting of a mixture comprising the solvent for the fluoropolymer and the nonsolvent for the fluoropolymer, the proportion of solvent for the fluoropolymer and/or of nonsolvent for the fluoropolymer varying in the various compositions to be tested, so as to select one or more of these compositions.

A vehicle composition (consisting of a mixture comprising the solvent for the fluoropolymer and the nonsolvent for the fluoropolymer) can then be selected if the fluoropolymer is estimated to be soluble therein.

When the function is applied successively to a plurality of mixtures comprising an increasing proportion of nonsolvent for the fluoropolymer, the process may make it possible to determine a range of proportions of nonsolvent for the fluoropolymer within which the solubility limit is estimated to be situated.

Thus, the solvent for the fluoropolymer and/or the nonsolvent for the fluoropolymer and/or the proportions of solvent and of nonsolvent in the vehicle comprising the solvent for the fluoropolymer and the nonsolvent for the fluoropolymer may be chosen according to a selection process performed by computer and comprising:
a) the provision of a function configured to associate a probability of solubility of the fluoropolymer with solubility parameters for a vehicle composition, for example a function determined by learning as described above;
b) the provision of solubility parameters associated with at least one vehicle composition (this vehicle composition being a mixture in the case of the selection of the proportions of solvent and of nonsolvent);
c) the application of the function supplied in step a) to the solubility parameters supplied in step b), so as to obtain a probability of solubility of the fluoropolymer associated with each respective vehicle composition;
d) depending on the case:
   the selection of a composition as solvent for the fluoropolymer, in which the fluoropolymer is estimated to be soluble, or
   the selection of a composition as nonsolvent for the fluoropolymer, in which the fluoropolymer is estimated to be insoluble, or
   the selection of a vehicle composition as a mixture comprising the solvent for the fluoropolymer and the nonsolvent for the fluoropolymer, in which the mass proportion of nonsolvent is estimated to be below the solubility limit, and is preferably estimated to be in one of the ranges mentioned above, relative to the solubility limit,

according to a predetermined test.

Such a process enables efficient, reliable, fast and easy selection since it does not necessarily require multiple dissolution experiments to be performed.

The vehicle composition selected can then be used to manufacture an ink by dispersing the fluoropolymer in said vehicle composition.

### Computer System

When it is a matter of a process performed by computer, it is understood that all or virtually all of the steps of the process are executed by a computer or a set of computers. The steps may be performed entirely automatically, or partially automatically. In certain embodiments, certain steps may be triggered in response to an interaction with a user. The envisaged degree of automation may be predefined and/or defined by the user.

By way of example, the distribution of the set of learning data between a set of training data and a set of test data may be decided by the user, or may be determined automatically.

The learning is performed automatically, according to any learning technique known to those skilled in the art. In particular, the error function is preferably automated according to any variant known to those skilled in the art.

With reference to FIG. 7, an example of a system that may be used to execute the processes performed by computer described above, via a computer program, is provided. In this example, the system is a computer, for example a workstation.

The computer thus comprises a processing unit 1010 connected to a bus 1000, and a random-access memory 1070 (RAM) also connected to the bus 1000. The computer also comprises a graphics processing unit 1110 which is associated with a video random-access memory 1100 connected to the bus. A mass storage device controller 1020 controls the access to a mass storage device, such as a hard disk 1030. The mass storage devices 1040 that are suitable for tangibly representing the computer program instructions and the data comprise all the forms of nonvolatile memory, including, for example, semiconductor memory devices of EPROM and EEPROM type and flash memory devices; magnetic disks such as internal hard disks and removable disks; magneto-optical disks and CD-ROM disks. These devices may also be supplemented with or incorporated into specific ASICs (application-specific integrated circuits). A network adapter 1050 controls the access to a network 1060. The computer may also comprise a haptic device 1090 such as a cursor control device, a keyboard or the like. A cursor control device is used to enable the user to selectively position a cursor anywhere on the display 1080. Furthermore, the cursor control device enables the user to select various input commands and control signals. The cursor control device comprises signal-generating devices for system input control signals. Typically, this device may be a mouse, the mouse button being used to generate the signals. The computer system may also comprise a touchscreen and/or a touchpad.

The computer program may comprise computer-executable instructions, the instructions comprising means for leading the above system to perform the process. The program may be recordable on any data support, including the system memory. The program may be run, for example, in digital electronic circuits, or in the computer hardware, firmware or software, or combinations thereof. The program may be run as an appliance, for example a product tangibly represented in a memory device which can be read by a machine to be run by a programmable processor. Process steps may be performed by a programmable processor running a program of instructions to perform functions of the process by processing input data and generating outputs. The processor may thus be programmable and may be coupled to receive data and instructions from, and to transmit data and instructions to, a memory device, at least one input device and at least one output device. The program may be run in a high-level procedural or object-oriented programming language, or in a machine language or assembly language. The language may be compiled or interpreted. The program may be a full installation program or an update program. Application of the program on the system leads to instructions for performing the process.

### EXAMPLES

The examples that follow illustrate the invention without limiting it.

### Example 1

### Solubility Estimation Model

A set of learning data was constituted from the following table:

TABLE 1

| Vehicle | δ_{d} | δₚ | δₕ | Solubility |
|---|---|---|---|---|
| Methyl ethyl ketone (2) | 14.1 | 9.3 | 9.5 | Yes |
| Methyl ethyl ketone (5) | 16 | 9 | 5.1 | Yes |
| Dimethyl sulfoxide (5) | 18.4 | 16.4 | 10.2 | Yes |
| Triethyl phosphate (5) | 16.8 | 11.5 | 9.2 | Yes |
| Ethyl acetate (2) | 13.4 | 8.6 | 8.9 | Yes |
| Ethyl acetate (5) | 15.8 | 5.3 | 7.2 | Yes |
| Cyclohexanone (2) | 15.6 | 9.4 | 11 | Yes |
| Cyclohexanone (5) | 17.8 | 6.3 | 5.1 | Yes |
| Cyclopentanone (2) | 16.2 | 11.1 | 8.8 | Yes |
| γ-Butyrolactone (2) | 18.6 | 12.2 | 14 | Yes |
| γ-Butyrolactone (5) | 19 | 16.6 | 7.4 | Yes |
| Acetone (2) | 13 | 9.8 | 11 | Yes |
| Acetone (5) | 15.5 | 10.4 | 7 | Yes |
| Tetrahydrofuran (2) | 13.3 | 11 | 6.7 | Yes |
| Tetrahydrofuran (5) | 16.8 | 5.7 | 8 | Yes |
| N,N-Dimethylformamide (5) | 17.4 | 13.7 | 11.3 | Yes |
| N,N-Dimethylacetamide (5) | 16.8 | 11.5 | 10.2 | Yes |
| Pyridine (2) | 17.6 | 10.1 | 7.7 | Yes |
| Pyridine (5) | 19 | 8.8 | 5.9 | Yes |
| Ethanol (2) | 12.6 | 11.2 | 20 | No |
| Glycerol (2) | 9.3 | 15.4 | 31.4 | No |
| Isopropanol (2) | 14 | 9.8 | 16 | No |
| Isopropanol (5) | 15.8 | 6.1 | 16.4 | No |
| Benzyl alcohol (5) | 18.4 | 6.3 | 13.7 | No |
| Benzaldehyde (5) | 19.4 | 7.4 | 5.3 | No |

In this table, the Hansen solubility parameters are given in MPa^{1/2}. The notations (2) or (5) indicate that these Hansen solubility parameters come either from table 2 of chapter 7 or from table 5 of chapter 8 of the CRC Handbook of Solubility Parameters and Other Cohesion Parameters, by Allan F. M. Barton, 2^{nd} edition (1991).

The information relating to the solubility was obtained experimentally with a P(VDF-TrFE) copolymer comprising 80% of VDF units and 20% of TrFE units (as molar proportions).

The software JMP 13.0.0 from the company SAS was used to provide a neural network as represented schematically in FIG. 6.

20 lines of the table were used for the learning of the model and six for the validation. The degree of success obtained is 100%.

The “KFold” validation method was used. This method, as explained in the software manual, divides the data into K subgroups. Each of the K subgroups is successively used to validate the “fit” or model created with the remainder of the data not included in the subgroup K, which makes it possible to obtain K different models. The model having the best statistical validation (the smallest error) is chosen as the final model.

From this modeling, the following prediction model was obtained.

Functions of the three neurons of the intermediate (hidden) layer:
H1=tan h (0.5×(0.288078×δ_{d}+0.029058×δₚ+0.092642×δₕ−4.79788));
H2=tan h (0.5×(0.131723×δ_{d}−0.16692×δₚ−0.03299×δₕ−0.05098));
H3=tan h (0.5×(0.399484×δ_{d}−0.11103×δₚ−0.05299×δₕ−4.13038)).

In the foregoing, the Hansen solubility parameters are expressed in MPa^{1/2}.

Function of the output neuron: S=exp (201.3275×H1+192.4403×H2−156.203×H3−82.4311).

The probability of insolubility (or of non-dissolution) is equal to S/(1+S) and the probability of solubility is equal to 1-probability of insolubility.

The model thus obtained may be applied to any new vehicle composition not present in the preceding learning table.

### Selection of a Vehicle for the Ink

The model described above is used to evaluate the probabilities of dissolution (or of solubility) of a P(VDF-TrFE) copolymer comprising 80% of VDF units and 20% of TrFE units (as molar proportions) (“FC-20” copolymer) in various mixtures of benzyl alcohol and γ-butyrolactone. As indicated above, γ-butyrolactone is a solvent for FC-20 and benzyl alcohol is a nonsolvent for the FC-20 copolymer.

These probabilities of dissolution are given in the table below (the first two columns of the table represent the mass proportion of the substance in the evaluated mixture).

TABLE 2

| Benzyl alcohol | γ-Butyrolactone | Probability of | Probability of |
|---|---|---|---|
| (weight %) | (weight %) | dissolution | non-dissolution |
| 4.65 | 95.35 | 1.0000 | 0.0000 |
| 9.34 | 90.66 | 1.0000 | 0.0000 |
| 14.06 | 85.94 | 1.0000 | 0.0000 |
| 18.81 | 81.19 | 1.0000 | 0.0000 |
| 23.60 | 76.40 | 1.0000 | 0.0000 |
| 28.43 | 71.57 | 1.0000 | 0.0000 |
| 38.19 | 61.81 | 1.0000 | 0.0000 |
| 48.10 | 51.90 | 1.0000 | 0.0000 |
| 58.17 | 41.83 | 0.9991 | 0.0009 |
| 68.38 | 31.62 | 0.0128 | 0.9872 |

The solubility limit (switching from a non-precipitating to a precipitating mixture) is between a proportion of about 58% and a proportion of about 68% by weight of benzyl alcohol. Thus, any mixture including a solvent-based liquid vehicle composed of less than 58% by weight of benzyl alcohol and of more than 42% by weight of γ-butyrolactone, relative to the total sum of the weights of benzyl alcohol and of γ-butyrolactone, could potentially be used as a vehicle for the ink for the manufacture of porous films.

### Preparation of a Polymer Film

An ink containing 8.34% by weight (relative to the total weight of the ink) of FC-20 copolymer in a mixture of 17.1% by weight of benzyl alcohol and 82.9% by weight of γ-butyrolactone is prepared as follows. The FC-20 copolymer is dissolved in the γ-butyrolactone/benzyl alcohol mixture by gradually adding, with stirring, the copolymer powder to the mixture, in a stirred container. To accelerate the dissolution, the mixture may be heated during the dissolution to a temperature below 70° C.

The ink thus obtained is deposited at room temperature onto a glass plate using a bar coater of doctor blade type (blade not coming into contact with the glass). The deposit is left to dry (i.e. left to undergo evaporation) at room temperature overnight in a fume cupboard. A brittle white film of uniform appearance is thus obtained. The typical thickness of the film is 80 μm.

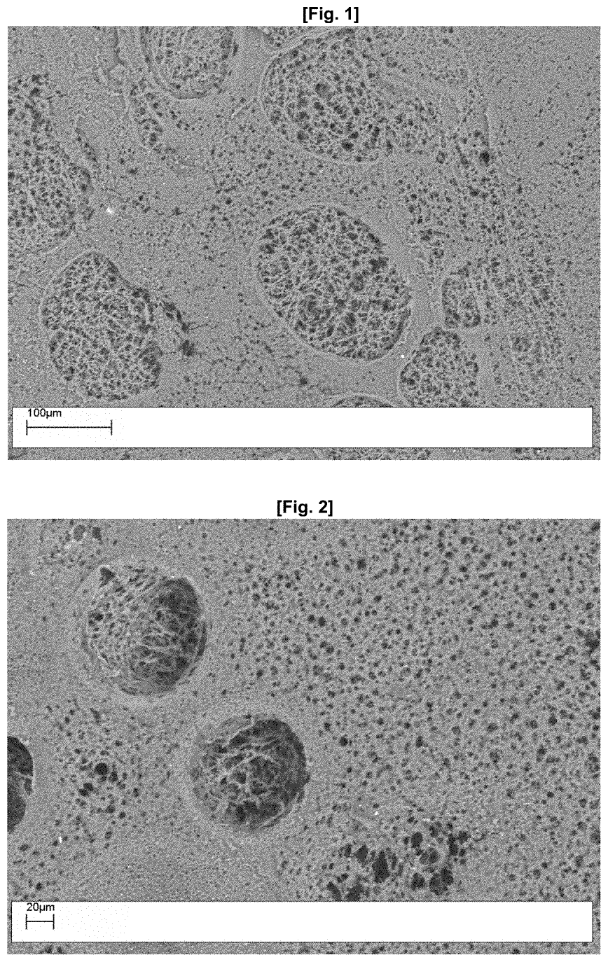

Images of the film, obtained using a scanning electron microscope, are shown in FIGS. 1, 2 and 3.

### Example 2

An ink containing 8.3% by weight (relative to the total weight of the ink) of FC-20 copolymer in a mixture of 17.1% by weight of benzyl alcohol and 82.9% by weight of γ-butyrolactone is prepared.

Five deposits are then made with this ink on a glass plate using a bar coater of doctor blade type and the five deposits are then left to dry overnight in a fume cupboard, each at a different temperature: room temperature; 30° C.; 40° C.; 50° C.; or 60° C. Films from 10 to 50 μm thick are obtained.

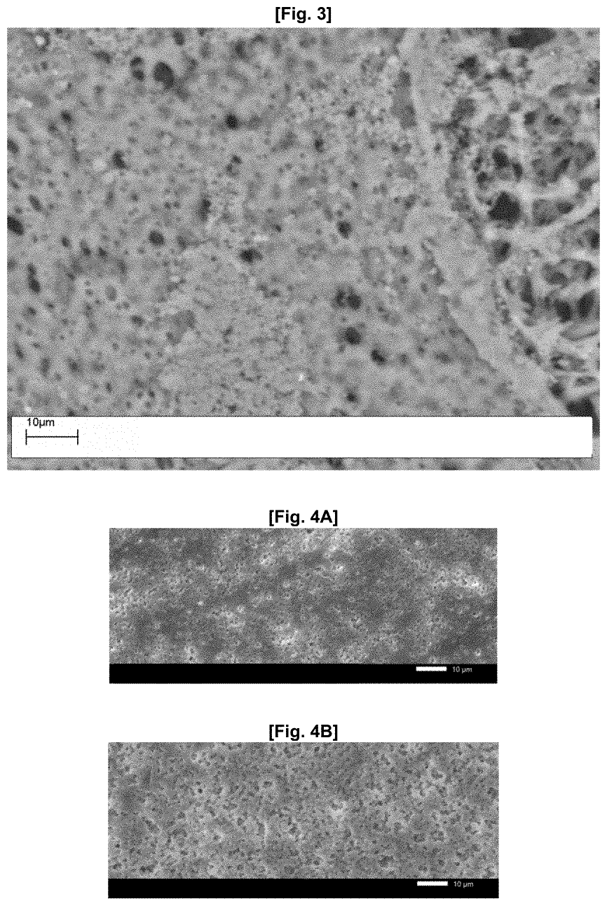

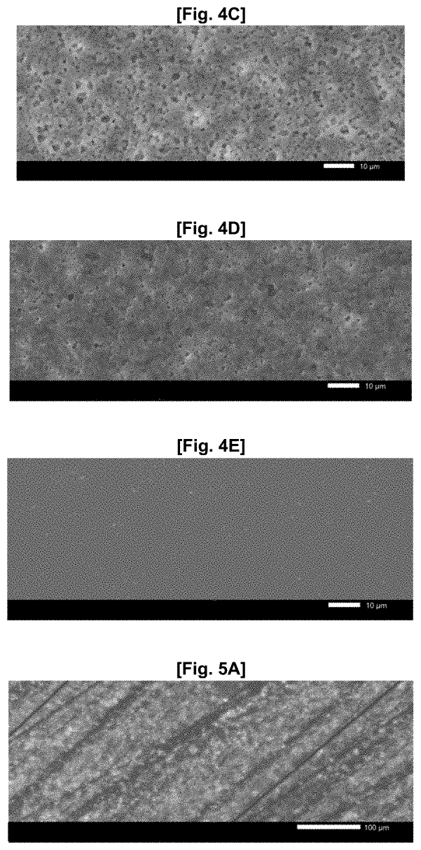

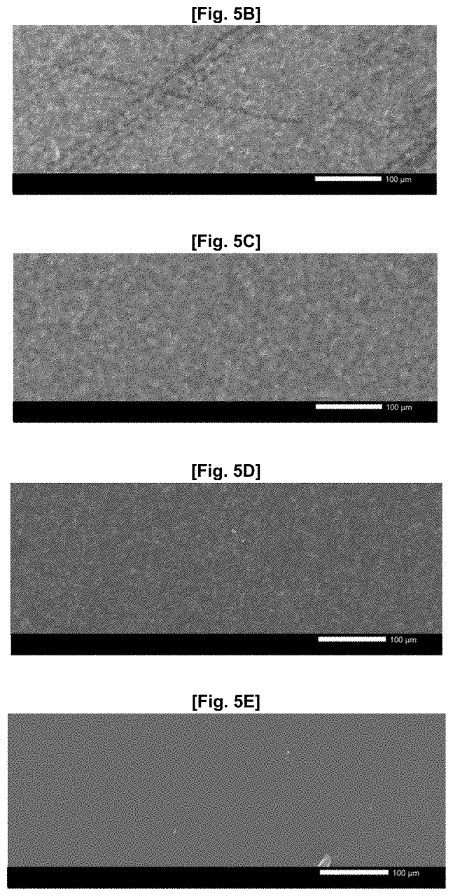

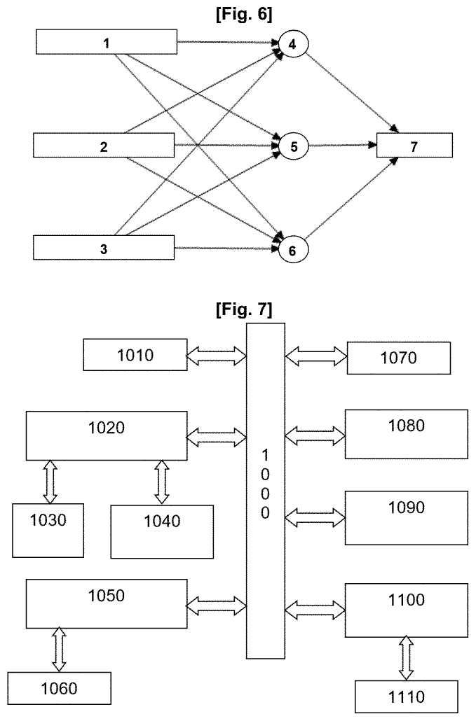

The films thus prepared are observed with a scanning electron microscope (FIGS. 4A, 4B, 4C, 4D and 4E) and with a light microscope (FIGS. 5A, 5B, 5C, 5D and 5E).

It is observed that the application of a drying temperature of 50° C., 40° C., 30° C. or equal to room temperature allows a porous white film to be produced, whereas the application of a drying temperature of 60° C. leads to a nonporous translucent film.

### Example 3

The films of Example 2, dried at different temperatures, were analyzed by porosimetry. A Micromeritics ASAP 2020 machine was used for this purpose. Between 140 and 270 mg of film are introduced into a measuring cell and degassing is performed at room temperature for 16 hours under a vacuum of less than 2 μmHg. The nitrogen adsorption-desorption isotherms are then measured at a temperature of 77 K (about −196° C.). The BET (Brunauer-Emmett-Teller) specific surface area is calculated by the machine at P/PO ratio values of between 0.06 and 0.2. The pore volume in the mesoporous and macroporous region is estimated by means of the BJH (Barrett-Joyner-Halenda) method.

The table below collates the results obtained:

| T | | Total pore | BJH pore volume | BET |
|---|---|---|---|---|
| annealing | Thickness | volume | between 1.7 and | surface area |
| (° C.) | (microns) | cm³/g | 50 nm (cm³/g) | (m²/g) |
| 20 | 30-50 | 0.028 | 0.0082 | 4.1 |
| 30 | 25-40 | 0.025 | 0.0063 | 3.2 |
| 40 | 25 | 0.023 | 0.0051 | 3.2 |
| 50 | 25 | 0.0096 | 0.0028 | 2.2 |

It is seen from these results that the lower the drying temperature, the higher the specific surface area and the pore volume. The sample dried at 60° C. could not be analyzed due to its heterogeneous appearance.

1. A process for preparing a porous film of a fluoropolymer, comprising the following steps:
the provision of an ink comprising the fluoropolymer and a vehicle comprising a solvent for the fluoropolymer and a nonsolvent for the fluoropolymer, said solvent for the fluoropolymer and said nonsolvent for the fluoropolymer being mutually miscible;
the deposition of the ink on a substrate;
the evaporation of the vehicle comprising the solvent and the nonsolvent;
in which:
the nonsolvent is chosen from the group consisting of benzyl alcohol, benzaldehyde or a mixture thereof; and
the solvent has a saturating vapor pressure at 20° C. higher than that of the nonsolvent.

2. The process as claimed in claim 1, in which the fluoropolymer is a polymer comprising units obtained from vinylidene fluoride and also units obtained from at least one other monomer of formula CX₁X₂═CX₃X₄, in which each group from among X₁, X₂, X₃ and X₄ is independently chosen from H, Cl, F, Br, I and alkyl groups comprising from 1 to 3 carbon atoms, which are optionally partially or totally halogenated.

3. The process as claimed in claim 1, in which the solvent is chosen from the group consisting of ketones, esters, notably cyclic esters, dimethyl sulfoxide, phosphoric esters, carbonates, ethers, and a mixture thereof.

4. The process as claimed in claim 1, in which the solvent is γ-butyrolactone and the nonsolvent is benzyl alcohol, or the solvent is ethyl acetate and the nonsolvent is benzyl alcohol, or the solvent is methyl ethyl ketone and the nonsolvent is benzyl alcohol.

5. The process as claimed in claim 1, in which the vehicle comprises a mass proportion of nonsolvent for the fluoropolymer, as a percentage, in the range from (the solubility limit-60%) to the solubility limit; and/or the vehicle comprises a mass proportion of solvent for the fluoropolymer, as a percentage, in the range from (100-the solubility limit) to (100-(the solubility limit-60%)); relative to the total weight of the mixture of solvent and nonsolvent for the fluoropolymer, the solubility limit being expressed as a mass percentage.

6. The process as claimed in claim 1, in which the evaporation of the vehicle comprising the solvent and the nonsolvent is performed at a temperature of less than or equal to 60° C.

7. The process as claimed in claim 1, in which the solvent has a boiling point below that of the nonsolvent.

8. The process as claimed in claim 1, in which the deposition is performed by spin coating, spray coating, coating with a bar or a film spreader, slot-die coating, dip coating, roll-to-roll printing, screen printing, flexographic printing, lithographic printing or inkjet printing.

9. The process as claimed in claim 1, in which the ink does not comprise any sacrificial polymer.

10. The process as claimed in claim 1, in which the temperature applied during the evaporation of the vehicle comprising the solvent and the nonsolvent is essentially constant or varies by less than 20° C.

11. The process as claimed in claim 1, for manufacturing a filtration or separating membrane, or a battery membrane.

12. A porous film that may be obtained via the process as claimed in claim 1, said film having a pore volume estimated by the Barrett-Joyner-Halenda method ranging from 0.020 cm³/g to 0.05 cm³/g.

13. A porous film that may be obtained via the process as claimed in claim 1, said film having a BET specific surface area of greater than or equal to 2.
